(19) United States
(12) Patent Application Publication
(10) Pub. No.: US 2015/0246837 A1
(43) Pub. Date: Sep. 3, 2015

(54) METHOD FOR TREATING FLUID RESULTING FROM HYDRAULIC FRACTURING WITH LIQUID/SOLID SEPARATION

(71) Applicant: Nijhuis Water Technology B.V., Doetinchem (NL)

(72) Inventors: Dana Dale WREGGLESWORTH, Doetinchem (NL); Eddie Broeders, Doetinchem (NL); Hendrik Willem Herman Menkveld, Doetinchem (NL)

(73) Assignee: Nijhuis Water Technology B.V., Doetinchem (NL)

(21) Appl. No.: 14/637,111

(22) Filed: Mar. 3, 2015

(30) Foreign Application Priority Data
Mar. 3, 2014 (NL) 2012353

(51) Int. Cl. C02F 9/00; E21B 43/34

(52) U.S. Cl. CPC C02F 9/00; E21B 43/34; C02F 1/545

(57) ABSTRACT

The invention relates to a method for treating fluid (2) resulting from hydraulic fracturing with liquid/solid separation (3), comprising the steps of:

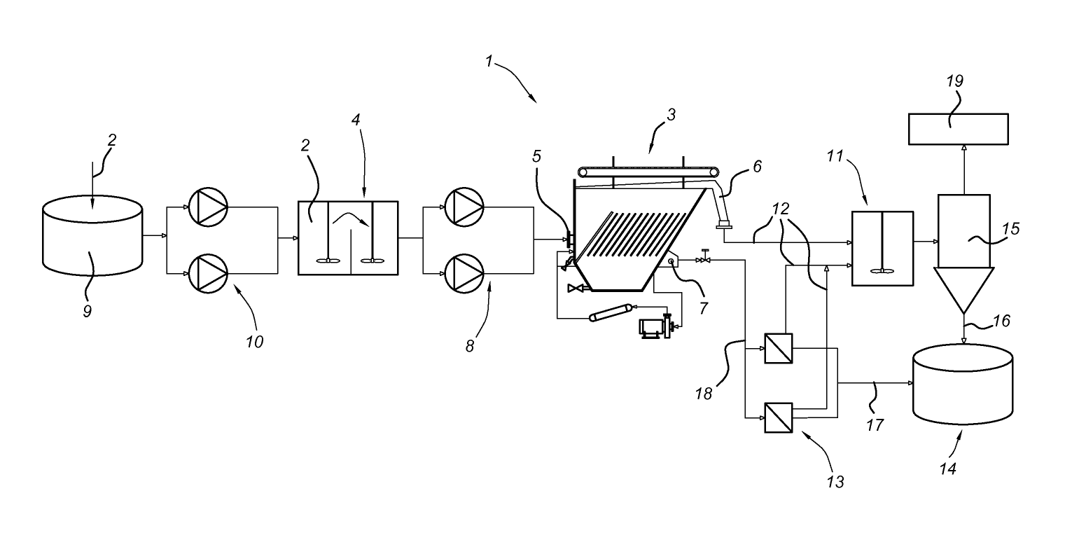

receiving the fluid in a vessel (4), such as a mixing tank or a plug flow reactor,

adding a chemical mix comprising organoclay to the fluid in the vessel to reduce levels of dissolved salts and organic compounds and molecules, and to allow coagulation and flocculation to occur,

adding pH-adjustment chemicals to the fluid in the vessel to reduce water hardness,

adding a micaceous metal complexing agent to the fluid in the vessel to at least partially remove ionic or complexed metalloids.

The invention also relates to an assembly for carrying out the method as well as a vessel to be used therein.

### FIELD OF THE INVENTION

The present invention relates to a method for treating fluid, such as waste water or ‘flow-back water’, resulting from hydraulic fracturing, sometimes known as ‘fracking’, in particular unconventional hydraulic fracturing.

### BACKGROUND OF THE INVENTION

The upstream oil and gas niche within the larger oil and gas marketplace has offered ample opportunity for development of novel processes to recover and reuse water produced during either fracking or oil sands operations.

However, many unknowns exist and the array of answers and their processes have been staggering in their variety, function and capabilities.

Given that all shale gas plays are different in geology, the rheology characteristics needed to consistently drill for and produce product, while still having a consistent water reuse quality from play to play, has proven not possible.

A particular problem with hydraulic fracturing is the presence of relic formation waters (‘relic water’) in the play, having a substantially negative effect on the reuse quality of the water.

It is therefore an object of the present invention to provide a method for treating fluid resulting from hydraulic fracturing, in particular unconventional hydraulic fracturing, wherein the waste water can be reused for subsequent fracturing operations.

It is a further object of the invention to provide a method for treating fluid resulting from hydraulic fracturing, wherein water reuse quality from play to play is relatively consistent.

### SUMMARY OF THE INVENTION

Hereto, a method for treating fluid resulting from hydraulic fracturing with liquid/solid separation is provided, comprising the steps of:

receiving the fluid in a vessel, such as a mixing tank or a plug flow reactor,

adding a chemical mix comprising organoclay to the fluid in the vessel to reduce levels of dissolved salts and organic compounds and molecules, and to allow coagulation and flocculation to occur,

adding pH-adjustment chemicals to the fluid in the vessel to reduce water hardness,

adding a micaceous metal complexing agent to the fluid in the vessel to at least partially remove ionic or complexed metalloids.

The inventors have shown the insight that the above method can consistently produce a “water white” product that is suitable generally 70-80% of the time for down hole reuse. Furthermore, water reuse quality from play to play appears to be relatively consistent.

The above method also results in a stable waste solids product that can be (landfill-)disposed locally.

Another significant advantage of the above method is that the at least partial removal of metalloids or transitional metals (by absorption, and/or ion exchange), such as boron, prevents wearing of the drilling muds used with hydraulic fracturing.

Although the skilled person will know what is meant with the expression ‘micaceous’, it is noted, essentially superfluously, that ‘micaceous’ primarily relates to the chemical properties of the metal complexing agent.

The process of treating fluid from fracturing wells thus basically focuses on three types of contaminants in order to reuse the fluid for other wells. The existence of these contaminants can be specific for each well.

The dissolved salts may include sulphates, phosphates, carbonates, bicarbonates, chlorides or perborates. These salts usually represent great difficulty with sequential treatment with physical chemistry. The method according to the invention effectively removes the metal ions of (certain) such salts.

The organoclay may comprise sodium bentonite or montmorrilonite clay. Apart from organoclay, components may be added to the chemical mix to enhance coagulation and/or flocculation. Sodium bentonite aggressively absorbs water. However, when in the presence of immiscible hydrocarbons sodium bentonite selectively absorbs hydrocarbons before water due to polar charge.

The pH-adjustment chemicals lower the fluid hardness since for reuse rheology purposes very low levels of calcium and magnesium are required.

Furthermore, the disclosed process will not materially affect down hole water reuse by causing corrosivity or other similar related issues.

It is conceivable that one step of the method is carried out in the vessel, whereas one or more subsequent steps are carried out in one or more vessels or water treatment areas downstream of the vessel. ‘Vessel’ is to be interpreted in the context of this patent application as a reservoir, container, tank or the like suitable for holding a quantity of fluid.

For illustrative purposes, applicant here below provides some results obtained with experiments, showing the effectiveness of the method according to the invention compared to the prior art methods.

The first table relates to flow-back water and shows respective removal efficiencies:

| | | Flow-back | After | Flow-back | After |
|---|---|---|---|---|---|
| Parameter | Unit | sample 1 | treatment | sample 2 | treatment |
| TPH | ppm | 7.5 | 0.3 | 0.35 | 0.10 |
| Bicarbonate | ppm | 1800 | <5 | 1900 | <5 |
| Carbonate | ppm | <5 | 1100 | <5 | 1300 |
| SO4 | ppm | 340 | 340 | 250 | 250 |
| Chlorides | ppm | 7480 | 7480 | 13500 | 13500 |
| Hardness | mg/l | 466 | N.D. | 13 | N.D |
| Sr | ppm | 20 | 4.7 | 88 | 37 |
| Fe | ppm | 79 | <5 | 22 | 0.31 |
| Al | ppm | 6.2 | 2.1 | 0.4 | 0.1 |
| Ba | ppm | 3 | 0.7 | 9.1 | 0.41 |
| Ca | ppm | 180 | 22 | 420 | 39 |
| Mg | ppm | 31 | <5 | 57 | <5 |
| Na | ppm | 5000 | 5000 | 6300 | 3600 |
| K | ppm | 67 | 67 | 140 | 140 |
| B | ppm | 15 | 4 | 73 | 19 |

The second table, shown here below, relates to produced water and analogously shows the respective removal efficiencies obtained with the method according to the invention:

| | | Produced | After |
|---|---|---|---|
| Parameter | Unit | water | treatment |
| TPH | ppm | 78 | 3.4 |
| Bicarbonate | ppm | 830 | <5 |
| Carbonate | ppm | <5 | 700 |
| SO4 | ppm | 68 | 68 |
| Chlorides | ppm | 14100 | 14100 |
| Hardness | mg/l | 1100 | N.D. |
| Sr | ppm | 48 | 6.5 |
| Fe | ppm | 5.2 | <1 |
| Al | ppm | <0.05 | <0.05 |
| Ba | ppm | 15 | <5 |
| Ca | ppm | 350 | 170 |
| Mg | ppm | 48 | <1 |
| Na | ppm | 7800 | 7800 |
| K | ppm | 35 | 35 |
| B | ppm | 24 | 6 |

The above tables show that the method according to the invention achieves high rates of removal of TPH, bicarbonate, Sr, Fe, Al, Ba, Ca, Mg and B for both flow-back water as well as produced water. Furthermore, the water hardness has decreased to virtually undetectable levels. Especially, it can be seen that around 70% B has been removed.

The use of chemistry and inert gases closely coupled with instrumentation of a specific type will allow at scale water reuse and prevent the addition of gases such as oxygen which are closely related to corrosivity and other similar related issues.

An embodiment relates to a method, wherein the steps are carried out in a consecutive manner. Therein, it is possible that the initial steps are carried out in the vessel, whereas the subsequent steps are carried out in water treatment areas downstream of the vessel. The inventors have noted that the best results are to be achieved when the steps are carried out consecutively.

In another embodiment, the dosage of the chemical mix is calculated based on influent turbidity and treated or processed fluid total suspended solids (TSS) particle type and amount of particles. This provides better control, higher process efficiency and improved process stability for the wide range of molecules expected.

Another embodiment relates to a method, wherein coagulation, flocculation and ion exchange are allowed to occur within the vessel such that insoluble solids are formed, wherein the insoluble solids are subsequently removed by a Dissolved Gas Flotation (DGF) device, such as a Dissolved Nitrogen Flotation (DNF) device or an Induced Gas Flotation (IGF) device. Such a DGF is very efficient at removing solids and remaining oil/gasses. Thus, in contrast with prior art methods, wherein gas is stripped and oil is flotated, the present method flocculates and absorbs oils and gasses to be flotated. Preferably, anionic as well as cationic polymers are added as flocculants. The use of reducing additives is preferably avoided.

Yet another embodiment relates to a method, wherein a turbidity and/or particle size sensor is used on an influent and/or treated or processed fluid of the Dissolved Gas Flotation device to determine if hydration time, reaction time, mixing energy and temperature of the organoclay in the vessel are within a predetermined range. This also provides better control, higher process efficiency and improved process stability for the wide range of molecules expected.

A further embodiment concerns a method, wherein the step of adding pH-adjustment chemicals comprises the addition of caustic soda and/or soda ash. Caustic soda and/or soda ash is a relatively optimal choice for achieving pH-adjustment and for removing calcium and other, similar salts.

Therein, the step of adding caustic soda and soda ash may advantageously comprise the addition of a liquid or solid comprising 50% caustic soda and/or soda ash, being a relatively optimal dosage for achieving the desired pH-adjustment.

Preferably the pH-adjustment chemicals, such as caustic soda and soda ash, are added to the fluid in the vessel in such quantities as to maintain a pH-value of 8.0-12.0, preferably 9.0-10.0. This pH-range proves to be a good choice for removing salts.

Advantageously, the vessel is a plug flow reactor or a mixing tank.

Another aspect of the invention relates to an assembly of a vessel and a separator device for carrying out the aforementioned method, comprising:

a vessel for receiving the fluid resulting from hydraulic fracturing,

a separator device, arranged downstream of the vessel, having an inlet in fluid connection with an outlet of the vessel for separating solid fractions from liquid fractions, the separator device having a solid fraction outlet and a treated or processed fluid outlet.

In an embodiment of the assembly, a first pumping skid is arranged between the vessel and the separator device for pumping the fluid to the treatment system comprising the separator device.

Another embodiment concerns an assembly, wherein a storage vessel for receiving the fluid resulting from hydraulic fracturing is fluidly connected to the vessel, the storage vessel being arranged upstream of the vessel. The storage vessel therein is used as a buffer. The storage vessel is also advantageously used to stabilize the quality of the fluid.

Preferably, a second pumping skid is arranged between the vessel and the storage vessel for pumping the fluid to the vessel for treatment.

In an advantageous embodiment, a solids collection vessel is fluidly connected to the solid fraction outlet of the separator device for collecting sludge.

Furthermore, an in-line filter can be fluidly connected to the treated or processed fluid outlet of the separator device for removing sludge from the treated or processed fluid, wherein an outlet of the in-line filter is fluidly connected to the solids collection vessel for transporting the removed sludge thereto. Thus, the additional filtering causes the amount of TSS or solids in the reusable water to be reduced to practically zero.

Another embodiment relates to an assembly, wherein an outlet of the in-line filter is fluidly connected to a re-use water collection vessel arranged downstream of the in-line filter to collect filtrate from the in-line filter for re-use purposes. Therein, the water collection vessel can be advantageously used for carrying out measurements, establishing control points, such as TSS, turbidity, pH, et cetera, to see if the upstream treatment process is functioning in an optimal way.

Preferably, the separator device comprises a separator device as disclosed in the international PCT-publication WO 2005/099857 by the present applicant. The contents of WO 2005/099857 are herewith incorporated by reference thereto in the present patent application. The system of plates disclosed in WO 2005/099857 is particularly suitable for use with the present method, leading to significantly reduced retention times.

In a further embodiment of the assembly, a dewatering device is fluidly connected to an outlet of the solids collection vessel, the dewatering device being arranged downstream of the solids collection vessel, the dewatering device having a solids outlet and a water outlet, wherein the water outlet is fluidly connected to the re-use water collection vessel.

Another aspect of the invention concerns a vessel for use in the aforementioned method or for use in the aforementioned assembly, wherein the vessel is sized according to hydration time, reaction time, mixing energy and temperature of the organoclay.

Applicant notes that US 2013/0313199 at first sight appears to disclose some essential aspects of the invention. However, US 2013/0313199 seeks to recover products from produced or flow-back water, whereas the present invention seeks to provide a pre-treatment for brine water and brackish water, which preferably is to be post-treated downstream with suitable treatment systems. The method according to the invention can be used advantageously with water having a relatively low concentration of TDS, for instance 0-35000 mg/l.

The present invention allows for a small footprint, locally (=at the desired location in the field), while allowing for a high through-put.

### BRIEF DESCRIPTION OF THE DRAWINGS

An embodiment of an assembly according to the invention will by way of non-limiting example be described in detail with reference to the accompanying drawings. In the drawings:

The FIGURE shows an exemplary embodiment of an assembly for carrying out the method according to the invention.

### DETAILED DESCRIPTION OF THE INVENTION

The FIGURE shows a schematic view of an exemplary embodiment of an assembly 1 for carrying out the method according to the invention.

The assembly 1 as shown comprises a vessel 4 and a separator device 3 for carrying out the method according to the invention. The vessel 4 is suitable for receiving the fluid 2 resulting from hydraulic fracturing. A separator device 3, such as a DNF or IGF, is arranged downstream of the vessel 4, having an inlet 5 in fluid connection with an outlet of the vessel 4 for separating solid fractions from liquid fractions. The separator device 3 has a solid fraction outlet 6 and a treated or processed fluid outlet 7.

A first pumping skid 8, for instance comprising two pumps, is arranged between the vessel 4 and the separator device 3. The pumping skids preferably are portable and rugged. The pumping skid 8 may be an automatic, lead/lag feed pumping skid.

A storage vessel 9 is shown for receiving the fluid 2 resulting from hydraulic fracturing. The storage vessel 9 is fluidly connected to the vessel 4, the storage vessel 9 being arranged upstream of the vessel 4.

A second pumping skid 10 is arranged between the vessel 4 and the storage vessel 9. The second pumping skid 10 may also comprise two pumps.

A solids collection vessel 11 is fluidly connected to the solid fraction outlet 6 of the separator device 3 for collecting sludge 12.

An in-line filter 13, such as for filtering particles having a particle size of 30-50 nm, is fluidly connected to the treated or processed fluid outlet 7 of the separator device 3 for removing sludge 12 from the treated or processed fluid, wherein an outlet of the in-line filter 13 is fluidly connected to the solids collection vessel 11 for transporting the removed sludge 12 thereto.

An outlet of the in-line filter 13 is fluidly connected to a re-use water collection vessel 14 arranged downstream of the in-line filter 13 to collect filtrate 17 from the in-line filter 13 for re-use purposes.

A dewatering device 15 is fluidly connected to an outlet of the solids collection vessel 11, the dewatering device 15 being arranged downstream of the solids collection vessel 11. The dewatering device 15 has a solids outlet and a water 16 outlet, wherein the water outlet is fluidly connected to the re-use water collection vessel 14. The solids from the solids outlet can for instance be disposed of in a landfill 19. The dewatering may be accomplished by means of a bag, wherein dewatering is carried out by the use gravity. A decanter/centrifuge can also be used for dewatering. After dewatering, the bags themselves can be placed on the landfill 19.

According to the invention, a method is provided for treating fluid 2 resulting from hydraulic fracturing with liquid/solid separation 3, comprising the steps of:

receiving the fluid in a vessel 4, such as a mixing tank or a plug flow reactor,

adding a chemical mix comprising organoclay to the fluid in the vessel 4 to reduce levels of dissolved salts,

adding pH-adjustment chemicals to the fluid 2 in the vessel 4 to reduce water hardness,

adding a micaceous metal (i.e. metalloid or transitional metal) complexing agent to the fluid 2 in the vessel 4 to at least partially remove ionic or complexed metalloids.

The steps are preferably carried out in a consecutive manner.

The dosage of the chemical mix is calculated based on influent turbidity and treated or processed fluid total suspended solids (TSS) particle type and amount of particles.

Coagulation, flocculation and ion exchange are allowed to occur within the vessel 4 such that insoluble solids, for instance flocs, are formed. The insoluble solids are subsequently removed by a Dissolved Gas Flotation (DGF) device 3, such as a Dissolved Nitrogen Flotation (DNF) device, for instance the DNF as sold by Nijhuis Water Technology B.V. of the Netherlands.

A turbidity and/or particle size sensor (not shown) is used on an influent and/or treated or processed fluid of the Dissolved Gas Flotation device 3 to determine if hydration time, reaction time, mixing energy and temperature of the organoclay in the vessel 4 are within a predetermined range.

The step of adding pH-adjustment chemicals can comprise the addition of caustic soda and/or soda ash. The step of adding caustic soda and soda ash can comprise the addition of a liquid or solid comprising 50% caustic soda and/or soda ash.

The pH-adjustment chemicals are preferably added to the fluid in the vessel in such quantities as to maintain a pH-value of 8.0-12.0, preferably 9.0-10.0.

The vessel 4 preferably is a plug flow reactor or a mixing tank, such as provided with mixing propellers as shown.

Thus, the invention has been described by reference to the embodiments discussed above. It will be recognized that these embodiments are susceptible to various modifications and alternative forms well known to those of skill in the art without departing from the spirit and scope of the invention. Accordingly, although specific embodiments have been described, these are examples only and are not limiting upon the scope of the invention.

### REFERENCE NUMERALS

1. Assembly
2. Fluid resulting from hydraulic fracturing
3. Liquid/solid separation
4. Vessel
5. Separator device inlet
6. Separator device outlet for solid fractions
7. Separator device outlet for treated or processed fluid
8. First pumping skid
9. Fluid storage vessel
10. Second pumping skid
11. Solids collection vessel
12. Sludge
13. In-line filter
14. Re-use water collection vessel
15. Dewatering device
16. Water
17. Filtrate
18. Treated or processed fluid of separator device
19. Landfill

1. A method for treating fluid resulting from hydraulic fracturing with liquid/solid separation, comprising:
(a) receiving the fluid in a vessel;
(b) adding a chemical mix comprising organoclay to the fluid in the vessel to reduce levels of dissolved salts and organic compounds and molecules, and to allow coagulation and flocculation to occur,
(c) adding pH-adjustment chemicals to the fluid in the vessel to reduce water hardness,
(d) adding a micaceous metal complexing agent to the fluid in the vessel to at least partially remove ionic or complexed metalloids.

2. The method according to claim 1, wherein the steps are carried out in a consecutive manner.

3. The method according to claim 1, the chemical mix is added in an amount calculated based on influent turbidity and treated or processed fluid total suspended solids (TSS) particle type and amount of particles.

4. The method according to claim 2, wherein coagulation, flocculation and ion exchange are allowed to occur within the vessel such that insoluble solids are formed, wherein the insoluble solids are subsequently removed by a Dissolved Gas Flotation (DGF) device.

5. The method according to claim 4, wherein a turbidity and/or particle size sensor is used on an influent and/or treated or processed fluid of the Dissolved Gas Flotation device to determine if hydration time, reaction time, mixing energy and temperature of the organoclay in the vessel are within a predetermined range.

6. The method according to claim 1, wherein the pH-adjustment chemicals comprises caustic soda and/or soda ash.

7. The method according to claim 6, wherein the caustic soda and/or soda ash are added as a liquid or solid comprising 50% caustic soda and/or soda ash.

8. The method according to claim 1, wherein the pH-adjustment chemicals are added to the fluid in the vessel to maintain a pH-value of 8.0-12.0.

9. The method according to claim 8, wherein the pH-adjustment chemicals are added to the fluid in the vessel to maintain a pH-value of 9.0-10.0.

10. The method according to claim 1, wherein the vessel is a plug flow reactor or a mixing tank.

11. An assembly of a vessel and a separator device, comprising:
(a) a vessel for receiving a fluid resulting from hydraulic fracturing, and
(b) a separator device, arranged downstream of the vessel, having
(i) an inlet in fluid connection with an outlet of the vessel for separating solid fractions from liquid fractions,
(ii) a solid fraction outlet, and
(iii) a treated or processed fluid outlet.

12. The assembly according to claim 11, further comprising a first pumping skid is arranged between the vessel and the separator device.

13. The assembly according to claim 11, further comprising a storage vessel for the fluid resulting from hydraulic fracturing, fluidly connected to the vessel and arranged upstream of the vessel.

14. The assembly according to claim 13, further comprising a second pumping skid arranged between the vessel and the storage vessel.

15. The assembly according to claim 11, further comprising a solids collection vessel fluidly connected to the solid fraction outlet of the separator device for collecting sludge.

16. The assembly according to claim 11, further comprising an in-line filter fluidly connected to the treated or processed fluid outlet of the separator device for removing sludge from the treated or processed fluid, wherein an outlet of the in-line filter is fluidly connected to the solids collection vessel for transporting the removed sludge thereto.

17. The assembly according to claim 16, wherein an outlet of the in-line filter is fluidly connected to a re-use water collection vessel arranged downstream of the in-line filter to collect filtrate from the in-line filter for re-use purposes.

18. The assembly according to claim 17, further comprising a dewatering device fluidly connected to an outlet of the solids collection vessel, the dewatering device being arranged downstream of the solids collection vessel and having a solids outlet and a water outlet fluidly connected to the re-use water collection vessel.
